(19) United States
(12) Patent Application Publication
(10) Pub. No.: US 2013/0332302 A1
(43) Pub. Date: Dec. 12, 2013

(54) METHODS AND SYSTEMS FOR MANAGING SOURCING OF STRATEGIC RESOURCES

(71) Applicants: John R. Stapleton, North Provo, UT (US); Gail S. Highsmith, Greenville, SC (US); Carl N. Friedholm, Greer, SC (US)

(72) Inventors: John R. Stapleton, North Provo, UT (US); Gail S. Highsmith, Greenville, SC (US); Carl N. Friedholm, Greer, SC (US)

(21) Appl. No.: 13/494,813

(22) Filed: Jun. 12, 2012

(51) Int. Cl. G06Q 30/00

(52) U.S. Cl. 705/26.4

(57) ABSTRACT

A computer-based method and system for management of sourcing of strategic resources for commercial entities is described. Internet/intranet-based portals are accessible by an administrator and one or more respondents representing prospective vendors to enable an administrator to create requests for information, proposals and/or quotations (RFx), and for respondents to submit responses to an RFx by answering questions presented in the RFx. The system also generates reports based on criteria established by the administrator and/or the commercial entity for which the RFx has been issued, using data compiled and/or generated from the answers provided by the respondents to the RFx.

### BACKGROUND OF THE INVENTION

The embodiments described herein relate generally to methods and systems for creating and issuing requests for proposals, quotations, or information, and receiving and evaluating responses to those requests for proposals, quotations, or information from respondents who represent and/or are contacts for prospective vendors.

Commercial entities (“CE”) that wish to acquire or expand strategic resources, such as telephone or internet services (provided by vendors) typically engage in a process for gathering the intelligence necessary to make an informed decision as to which vendor's products and/or services to engage. CE's may gather intelligence in the form of general information, and the process of obtaining general information about a vendor and its products and/or services may include a request for information (“RFI”). An RFI is a standard business process, the purpose of which is to collect written information about the capabilities of various vendors. Alternatively, a CE may engage in a request for qualifications (“RFQ”) process. In an RFQ process, a CE will describe a contemplated project or acquisition in sufficient detail to enable respondents to determine if the vendors they represent wish to compete for the business of the CE. A CE may also use a RFQ process as a first level of elimination to narrow the field of potential vendors. The RFQ process is typically a precursor to a request for proposal (“RFP”) process. An RFP process is an early stage in a procurement process, in which a CE first defines the products and services (for example, telecommunications products and/or services) required to fulfill the needs of the CE in question. The CE then compares the proposals received from respondents, typically using in-house analysts to determine which prospective vendor has the best combination of pricing, strategy, quality control, facilities and resources, etc. Collectively, these processes may be referred to as Requests for X or “RFx.”

An RFx process typically entails having an administrator (hereinafter “admin”), whether an employee of the CE, or a third party vendor, that is tasked with the organization and management of the resource acquisition process. The acquisition process includes determining the requirements of the CE that must be met, receiving and processing of the responses to the RFx, and presenting the results of the responses to the individuals at the business responsible for making the final decision.

The admin creates a list of criteria, configured to address the needs of the CE with respect to the particular strategic resource of concern, and builds a formal request incorporating the list of criteria. The admin then announces that the CE is seeking proposals for a particular resource, either publicly, through a press release or similar mechanism, or privately, through direct communications to individual prospective vendors, with which the CE may or may not have had prior experience. The admin then receives the responses from the respondents, and typically performs processing of the responses, so that the responses of the various respondents are collected, and sorted according to various characteristics, to enable responses from multiple prospective vendors to individual components of the RFx to be compared.

Furthermore, the communications between a CE (via the admin) seeking such proposals, and the respondent(s) responding to the RFx, typically are direct, either through written hardcopy communications and presentations, or through electronic media, or a combination of both. In addition, such communications take place on a one-to-one basis; that is, between the admin and one respondent at a time.

The result of such a process is that the admin often engages in a duplication of effort in making prospective vendors aware of the RFx. Furthermore, considerable time, effort and manpower may be required in order to manually process the responses from multiple respondents to produce results that will enable those in the CE responsible for the final decision to do so as fully informed as possible.

It would be desirable to provide a web-based method and system for the management of the process by which a business creates and distributes requests for proposal (or other information) to prospective vendors for a resource, such as telecommunications or internet services.

It would also be desirable to provide a method and system for the management of the process by which a business creates and distributes requests for proposal (or other information) to prospective vendors for a resource, such as telecommunications or internet services, which alleviates the need for individualized communications between a business (or its proxy) and the respondents, and facilitates the processing of the responses of those respondents.

### BRIEF DESCRIPTION OF THE INVENTION

In one aspect, a computer-based method for management of sourcing of a strategic resource for a commercial entity is provided. The method is implemented using a computer system that includes a processor and a memory device. The method includes providing a web-based access interface to enable at least one of an administrator, and at least one respondent representing a prospective vendor to interact with, upload data into and download information from a web-based strategic resource sourcing management system. The method further includes storing a plurality of questions in a database, the questions being directed to one or more of a plurality of discrete topics concerning a strategic resource. The method further includes creating a request, using the computer system, and with criteria provided by at least one of the administrator and the commercial entity, the request incorporating one or more questions from the plurality of questions stored in the database. The method further includes receiving, from the at least one respondent, a response. The method further includes generating, using the computer system, at least one report, based on criteria provided by at least one of the administrator and the commercial entity, using data derived from the response, the report providing information to enable at least one of the administrator and the commercial entity to arrive at a decision whether to select the prospective vendor represented by the at least one respondent to provide a strategic resource to the commercial entity.

In another aspect, a system for managing the sourcing of a strategic resource for a commercial entity is provided. The system incorporates a computer system that includes a processor and a memory device. The system comprises a database configured to store data associated with at least one of an administrator, a commercial entity, and at least one respondent representing a prospective vendor; a database server; and one or more computers, each computer including a processing device and a memory. The database, database server, and one or more computers are configured to provide a web-based access interface to enable at least one of the administrator, commercial entity, and at least one respondent representing a prospective vendor to upload data into and download information from the database. The database, database server, and one or more computers are further configured to store a plurality of questions in a database, the questions being directed to one or more of a plurality of discrete topics concerning a strategic resource. The database, database server, and one or more computers are further configured to create a request, using the computer system, and with criteria provided by at least one of the administrator and the commercial entity, the request incorporating one or more questions from the plurality of questions stored in the database. The database, database server, and one or more computers are further configured to receive a response from the at least one respondent. The database, database server, and one or more computers are further configured to generate, using the computer system, at least one report, based on criteria provided by at least one of the administrator and the commercial entity, using data derived from the response, the report providing information to enable at least one of the administrator and the commercial entity to arrive at a decision whether to select the prospective vendor represented by the at least one respondent to provide a strategic resource to the commercial entity.

In another aspect, one or more non-transitory computer-readable storage media having computer-executable instructions embodied thereon are provided. When executed by at least one processor, the computer-executable instructions cause the processor to store a plurality of questions in a database, the questions being directed to one or more of a plurality of discrete topics concerning a strategic resource. The computer-executable instructions further cause the processor to create a request, using the computer system, and with criteria provided by at least one of the administrator and the commercial entity, the request incorporating one or more questions from the plurality of questions stored in the database. The computer-executable instructions further cause the processor to receive a response from the at least one respondent. The computer-executable instructions further cause the processor to generate, using the computer system, at least one report, based on criteria provided by at least one of the administrator and the commercial entity, using data derived from the response, the report providing information to enable at least one of the administrator and the commercial entity to arrive at a decision whether to select the prospective vendor represented by the at least one respondent to provide a strategic resource to the commercial entity.

### BRIEF DESCRIPTION OF THE DRAWINGS

FIG. 1 is a schematic illustration of parties involved in sourcing of strategic resources, illustrating the paths of communication between an admin, a commercial entity, and a plurality of respondents representing prospective vendors.

FIG. 2 is a simplified block diagram of an exemplary resource sourcing management system infrastructure in accordance with one embodiment of the present invention.

FIG. 3 is an expanded block diagram of exemplary server architecture of the resource sourcing management payment system shown in FIG. 2.

FIG. 4 illustrates an exemplary configuration of a user computing device shown in FIGS. 2 and 3.

FIG. 5 illustrates an exemplary configuration of a server computing device as shown in FIGS. 2 and 3.

FIG. 6 is a flowchart illustrating an exemplary process for creating a request for sourcing a strategic resource that may be performed by the resource sourcing management systems shown in FIGS. 2 and 3.

FIG. 7 is a flowchart illustrating a further portion of an exemplary process for creating a request for sourcing a strategic resource that may be performed by the resource sourcing management systems shown in FIGS. 2 and 3.

FIG. 8 is a flowchart illustrating an exemplary process for responding to a request for sourcing a strategic resource that may be performed by the resource sourcing management systems shown in FIGS. 2 and 3.

FIG. 9 is a flowchart illustrating the report review process and the reports created by the resource sourcing management systems shown in FIGS. 2 and 3.

### DETAILED DESCRIPTION OF THE INVENTION

In one embodiment, a computer program is provided, and the program is embodied on a computer readable medium and utilizes a Structured Query Language (SQL) with a client user interface front-end for administration and a web interface for standard user input and reports. In an exemplary embodiment, the system is web enabled and is run on a business-entity intranet. In yet another embodiment, the system is fully accessed by individuals having an authorized access outside the firewall of the business-entity through the Internet. In a further exemplary embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. Users of the exemplary system and method should be familiar with typical internet browser interface and web page navigation.

The methods and systems described herein are configured to function as a stand-alone internet-based module. Alternatively, the methods and systems described herein may be integrated into a larger expense management application, such as the telecom expense management application presently marketed and operated by Cass Information Systems of St. Louis, Mo.

The methods and systems described herein facilitate the creation and distribution of RFx's by an admin, and the intake and processing of vendor responses to RFx's. While the systems and methods described herein are discussed in the context of CEs seeking information, quotations, and/or proposals from vendors for telecom products and/or services, it is to be understood that the systems and methods described herein may be applied to RFx's for other types of products and/or services without departing from the scope of the invention.

The system for managing sourcing of strategic resources may include an internet-based portal or interface through which an admin (which may be an employee of the CE or a third party) can create RFx's, and issue invitations to respondents to respond to the RFx's. The respondents, once provided with the appropriate credentials or authorizations by the admin, can access a respondent portal interface to respond to questions in an RFx, insert data, ask questions (e.g., for clarification), and/or upload supporting documents.

A technical effect of the systems and processes described herein include at least one of: (a) creating, by an admin, a RFx, compiled at least in part from previously-defined questions; (b) transmitting notices to respondents representing prospective vendors, advising them of the issuance of an RFx; (c) receiving, from respondents representing prospective vendors, answers to questions contained in an RFx; (d) processing and compiling the answers received from the respondents according to predefined criteria; and (e) periodically creating reports presenting data generated from the answers received from the respondents.

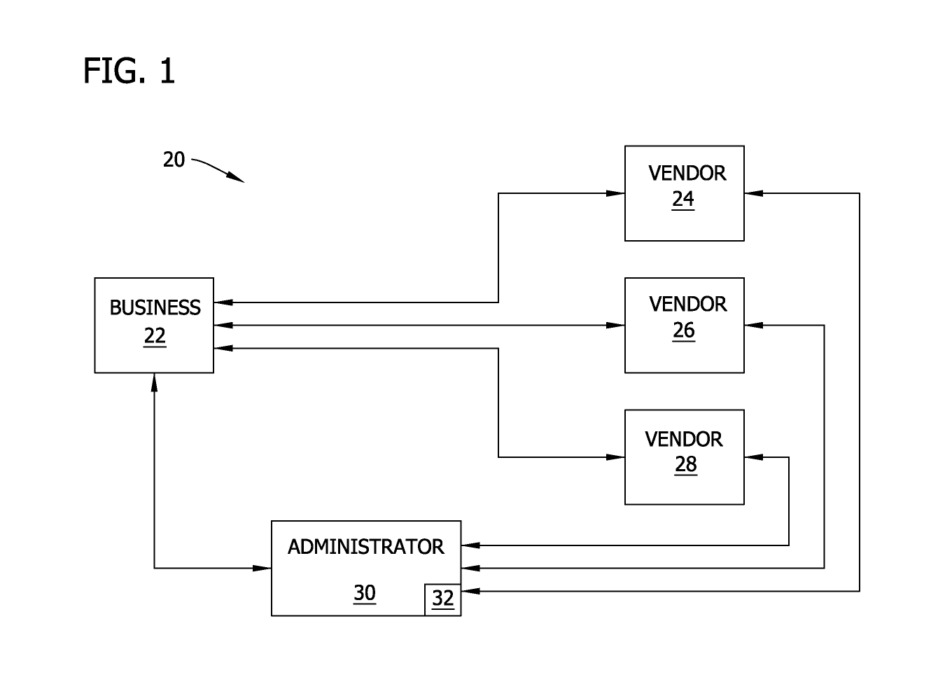

FIG. 1 is a schematic illustration of parties involved in sourcing of strategic resources, illustrating the paths of communication between an admin, a commercial entity, and a plurality of respondents representing prospective vendors. In the exemplary embodiment, scenario 20 includes a commercial entity (CE) 22, respondents 24, 26, and 28 (representing respective prospective vendors to CE 22), and admin 30. Although described herein as a commercial entity, CE 22 may include an individual, a charitable organization, and/or any other party seeking assistance in sourcing of strategic resources. A single respondent 24, etc., may act on behalf of each respective prospective vendor, addressing all aspects of an RFx on behalf of their corresponding prospective vendors. Alternatively, a prospective vendor may employ the services of a plurality of respondents, each tasked with addressing a specific portion or portions of the RFx.

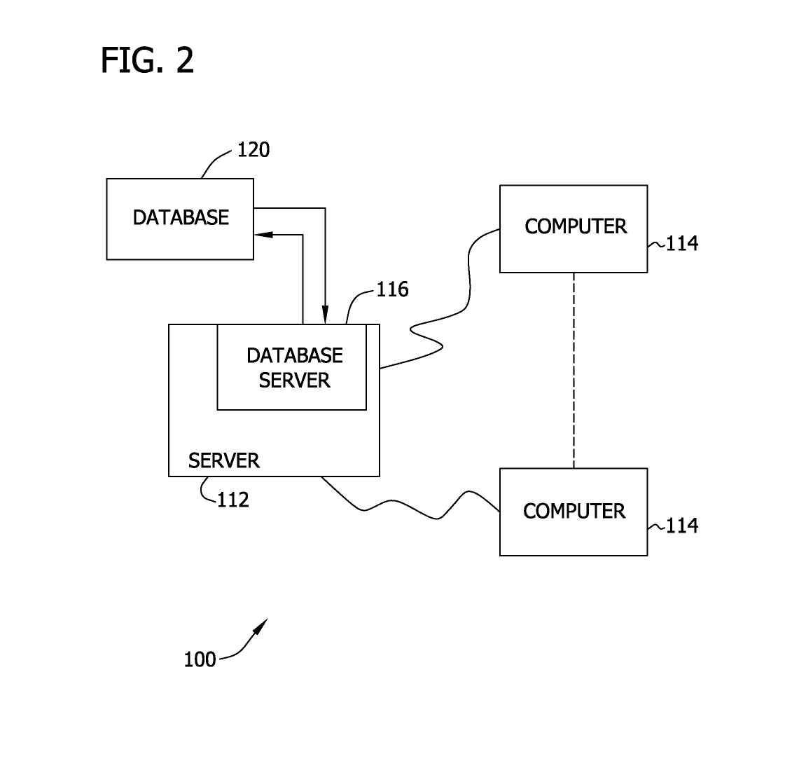

In the exemplary embodiment, each of CE 22, respondents 24, 26 and 28, and admin 30 are in two-way communication with each other, with such communication being provided by internet and/or telephonic connections, among other possible communication sources. In the exemplary embodiment, admin 30 incorporates a strategic sourcing management system 32 configured to perform the processes described herein. Furthermore, in the exemplary embodiment, admin 30 is a separate entity from CE 22, that is, a third-party who provides strategic resource sourcing management services. In an alternative embodiment, the functions of admin 30 and strategic sourcing management system 32 are included within, and performed by, CE 22. For example, strategic sourcing management system 32 may be maintained and operated by admin 30, and incorporate infrastructure 100 (shown in FIG. 2), configured to perform the methods and processes described herein.

In the exemplary embodiment, data and physical document acquisition and analysis functions are performed by system 32 (with input from admin 30), in addition to an actual strategic sourcing management function. In alternative embodiments, one or more of these functions may be performed by third parties other than admin 30. In addition, although illustrated as having three vendors, sourcing scenario 20 may include any number of vendors and strategic sourcing management system 32 may be configured to address responses to RFx's from any suitable number of respondents that allows strategic sourcing management system 32 to function as described herein.

FIG. 2 is a simplified block diagram of an exemplary infrastructure 100 used by system 32 in accordance with one embodiment of the present invention. In one embodiment, infrastructure 100 is a strategic sourcing management system, for example, strategic sourcing management system 32. System 32 receives requirements from admin 30, generates RFx's, and manages responses to those RFx's from respondents 24, 26 and 28, for prospective telecom products and services to be provided to CE 22.

More specifically, in the exemplary embodiment, infrastructure 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems and special high-speed ISDN lines. Client systems 114 could be any devices capable of interconnecting to the Internet including a web-based phone, personal digital assistant (PDA), or other web-based connectable equipment. A database server 116 is connected to database 120 containing information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

Database 120 stores data relating to the details of a CE's business, such as details and requirements associated the telecommunications needs that CE 22 may have, such as the number of personnel or business locations that CE may have. In addition, database 120 can also be used to store data pertaining to historical telecommunications usage by CE, if any, and historical contracts or business arrangements that CE may have or have had with existing or prospective vendors. The foregoing are intended to be examples of the types of data stored in database 120, and are not intended to be exhaustive or limiting.

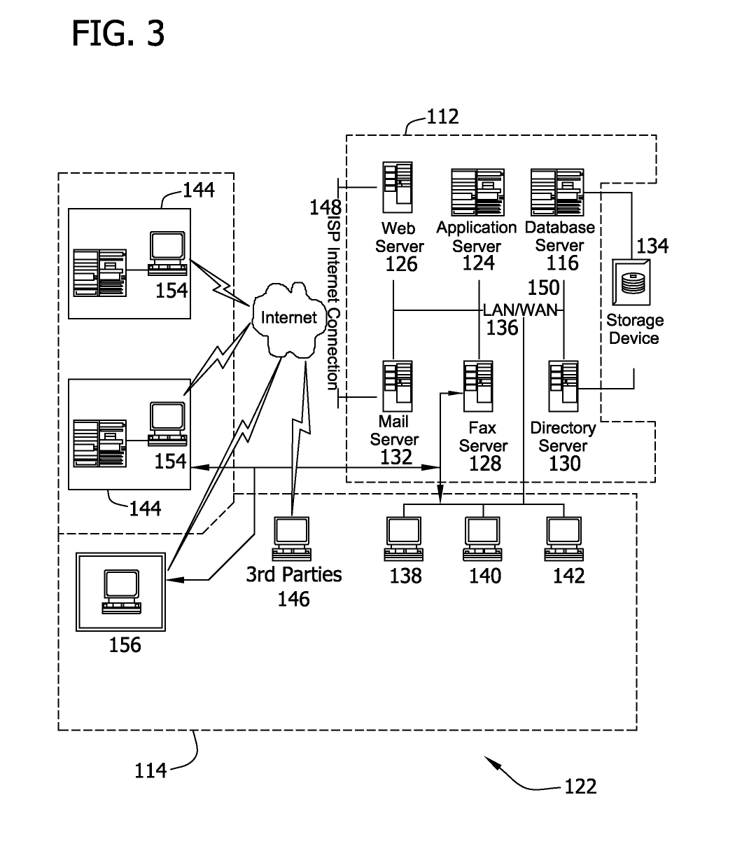

FIG. 3 is an expanded block diagram of an exemplary embodiment of server architecture of a system 122 in accordance with one embodiment of the present invention. Components in system 122, identical to components of infrastructure 100 (shown in FIG. 2), are identified in FIG. 3 using the same reference numerals as used in FIG. 2. System 122 includes server system 112 and client systems 114. Server system 112 further includes database server 116, an application server 124, a web server 126, a fax server 128, a directory server 130, and a mail server 132. A disk storage unit 134 is coupled to database server 116 and directory server 130. Servers 116, 124, 126, 128, 130, and 132 are coupled in a local area network (LAN) 136. In addition, a system admin's workstation 138, a user workstation 140, and a supervisor's workstation 142 are coupled to LAN 136. Alternatively, workstations 138, 140, and 142 are coupled to LAN 136 using an Internet link or are connected through an Intranet.

Each of workstations, 138, 140, and 142 may be any computing device that includes a web browser, for example, but not limited to, a personal computer, a laptop, a tablet computer and/or a mobile phone. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., CE 22, and respondents 24, 26, and 28, etc. (collectively, 3^{rd} parties 146), using an ISP Internet connection 148. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the exemplary embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

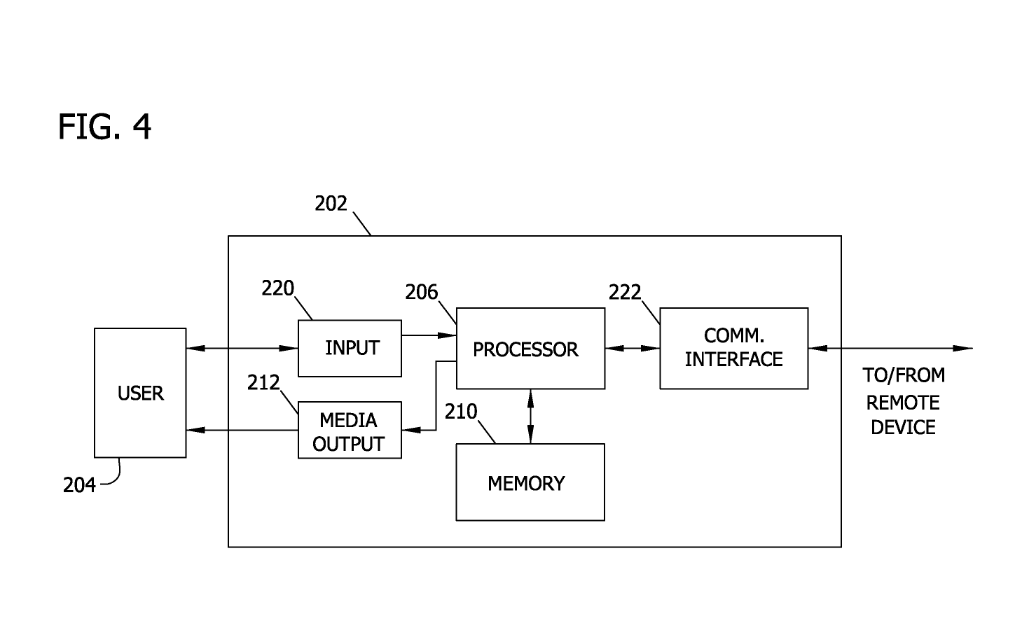

FIG. 4 illustrates an exemplary configuration of a user computing device 202 operated by a user 204. User computing device 202 may include, but is not limited to, client systems 114, 138, 140, and 142, workstation 154, and manager workstation 156.

User computing device 202 includes a processor 206 for executing instructions. In some embodiments, executable instructions are stored in a memory area 210. Processor 206 may include one or more processing units (e.g., in a multi-core configuration). Memory area 210 is any device allowing information such as executable instructions and/or written works to be stored and retrieved. Memory area 210 may include one or more computer readable media.

User computing device 202 also includes at least one media output component 212 for presenting information to user 204. Media output component 212 is any component capable of conveying information to user 204. In some embodiments, media output component 212 includes an output adapter such as a video adapter and/or an audio adapter. An output adapter is operatively coupled to processor 206 and operatively couplable to an output device such as a display device (e.g., a liquid crystal display (LCD), organic light emitting diode (OLED) display, or “electronic ink” display) or an audio output device (e.g., a speaker or headphones).

In some embodiments, user computing device 202 includes an input device 220 for receiving input from user 204. Input device 220 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 212 and input device 220.

User computing device 202 may also include a communication interface 222, which is communicatively couplable to a remote device such as server system 112. Communication interface 222 may include, for example, a wired or wireless network adapter or a wireless data transceiver for use with a mobile phone network (e.g., Global System for Mobile communications (GSM), 3G, 4G) or other mobile data network (e.g., Worldwide Interoperability for Microwave Access (WIMAX)).

Stored in memory area 210 are, for example, computer readable instructions for providing a user interface to user 204 via media output component 212 and, optionally, receiving and processing input from input device 220. The user interface may include, among other possibilities, a web browser and client application. Web browsers enable users, such as user 204, to display and interact with media and other information typically embedded on a web page or a website from server system 112. A client application allows user 204 to interact with a server application from server system 112.

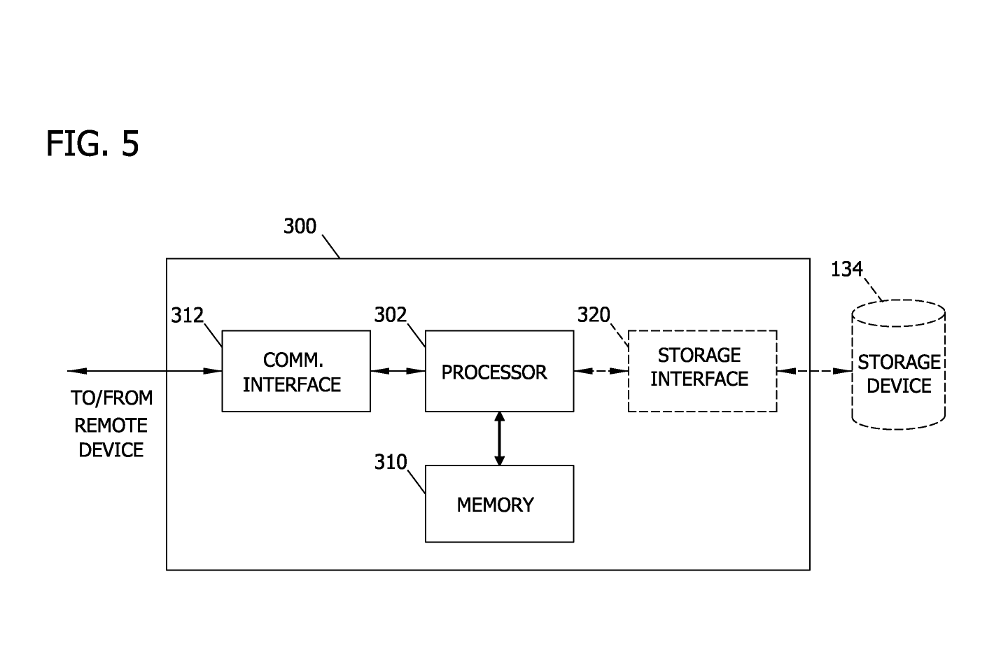

FIG. 5 illustrates an exemplary configuration of a server computing device 300 such as may be used in server system 112 (shown in FIG. 2). Server computing device 300 may include, but is not limited to, database server 116, application server 124, web server 126, fax server 128, directory server 130, and mail server 132.

Server computing device 300 also includes a processor 302 for executing instructions. Instructions may be stored in a memory area 310, for example. Processor 302 may include one or more processing units (e.g., in a multi-core configuration).

Processor 302 is operatively coupled to a communication interface 312 such that server computing device 300 is capable of communicating with a remote device such as user computing device 202 or another server computing device 300. For example, communication interface 312 may receive requests from user computing device 202 via the Internet, as illustrated in FIG. 3.

Processor 302 may also be operatively coupled to a storage device 134. Storage device 134 is any computer-operated hardware suitable for storing and/or retrieving data. In some embodiments, storage device 134 is integrated in server computing device 300. For example, server computing device 300 may include one or more hard disk drives as storage device 134. In other embodiments, storage device 134 is external to server computing device 300 and may be accessed by a plurality of server computing devices 300. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 302 is operatively coupled to storage device 134 via a storage interface 320. Storage interface 320 is any component capable of providing processor 302 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 302 with access to storage device 134.

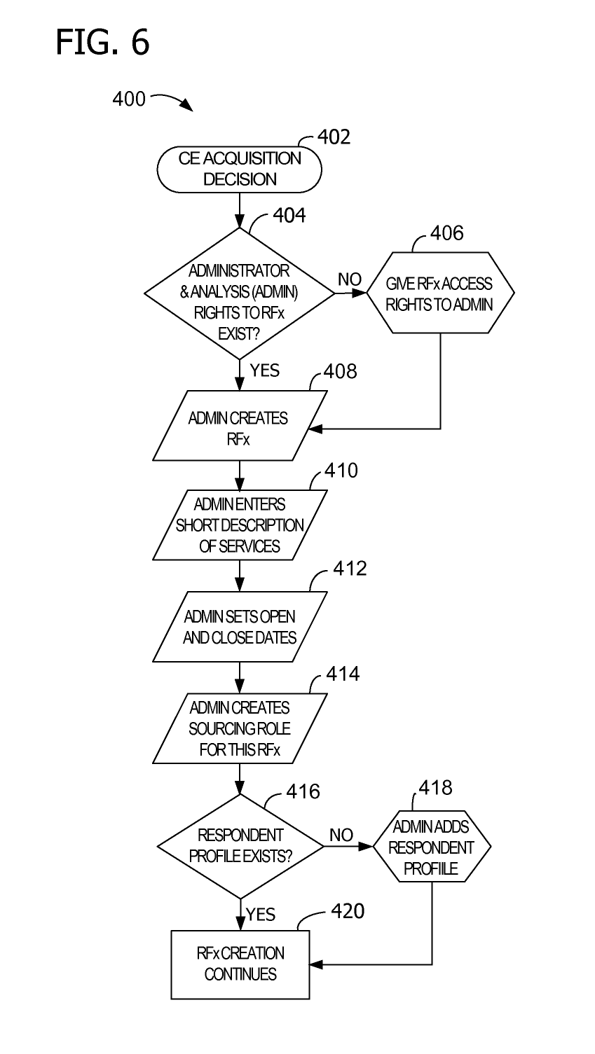

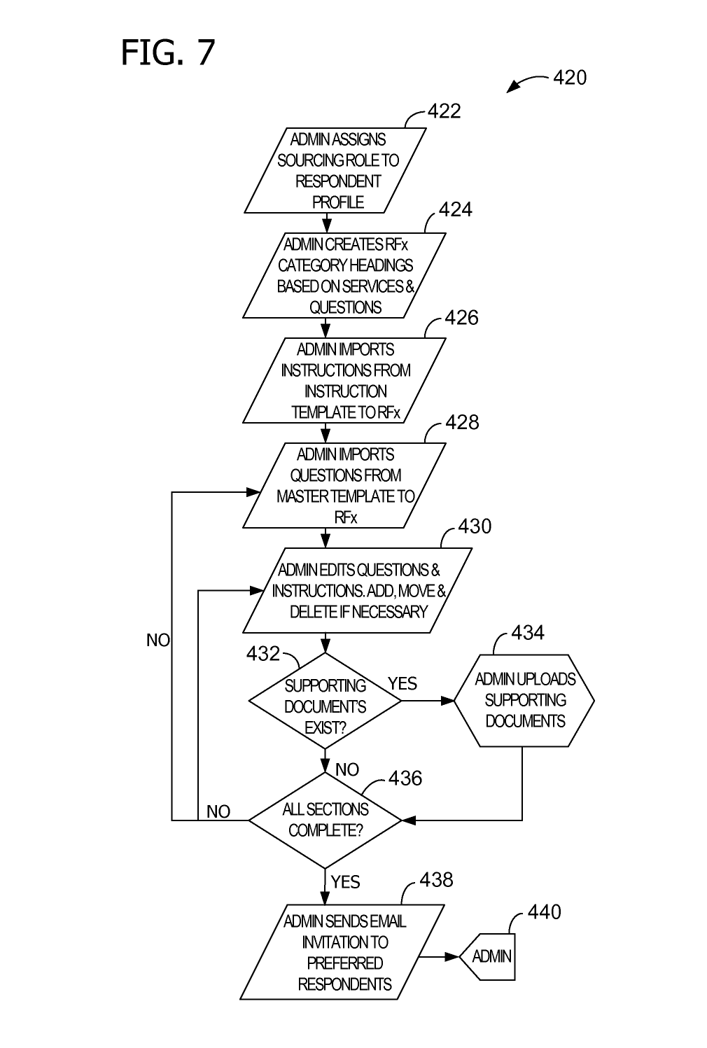

FIGS. 6 and 7 are flowcharts illustrating an exemplary method 400 for managing RFx's. In the exemplary embodiment, system 32 (shown in FIG. 1) performs method 400. Method 400 begins when CE 22 decides 402 to acquire a new strategic resource, or replace or modify an existing strategic resource, either event representing a major investment of time, effort and money on the part of CE 22. Admin 30 obtains general information from CE 22, with respect to the particular needs that CE 22 has, what CE 22's objectives are with regard to the particular resource CE 22 wishes to acquire, replace or supplement, the component or hardware requirements involved, general terms or conditions regarding the RFx process and/or the actual service or resource to be acquired, replaced or supplemented.

In the exemplary process of FIGS. 6 and 7, admin 30 represents not just personnel actually overseeing the RFx process, but also analysts working under the aforementioned personnel overseeing the RFx process, to review and process the results of the RFx process prior to turning over the results of the RFx process (possibly with recommendations) to decision-making personnel at CE 22. As discussed elsewhere herein, admin 30 may be employed by CE 22, or may be a third party independent contractor. In either situation, once CE 22 decides 402 to enter the RFx process, CE 22 determines whether admin 30 has access and entry rights to system 32. If admin 30 does not have access and entry rights to system 32, CE 22 gives 406 admin rights to access system 32, either externally through an internet-based portal or internally through an intranet-based portal. If admin 30 does have access and entry rights to system 32, admin 30 proceeds 408 directly to begin the process of creating the RFx requested by CE 22.

In the exemplary embodiment, an RFx created by system 32, through interaction with admin 30, includes several levels of precision. The RFx may include, for example, categories, sections, and/or questions. Categories are general topic headings concerning the issues, services, and technologies to which the RFx is directed. Sections are further breakdowns within each category to define more precisely the terms, conditions, services and technologies required to respond to the RFx. Questions are the final degree of precision in the RFx. Each section will contain questions for respondents to answer to describe how they may fulfill or meet individual requests identified in the RFx.

Once given access, system 32 displays a status screen showing admin 30 the status of RFx's that have been entered into system 32. The status may be open, pending, closing today (meaning that “today” is the end date that responses to an RFx will be accepted), and closed. System 32 may also prompt 408 admin 30 to begin the RFx process by presenting a screen to create a new RFX. System 32 prompts 410 admin 30 to enter a short description of the products and/or services that will be the subject of the RFx. System 32 may provide a menu of possible descriptions, or system 32 may enable admin 30 to write the description using their own words. System 32 then prompts 412 admin 30 to set the opening and closing dates for the period for response to the RFx, once notice of the RFx has been distributed to the prospective vendors. System 32 then prompts 414 admin 30 to create a sourcing role for the RFx. That is, a typical RFx may include separate sections or portions that address, for example, separate features or services covered by the RFx. Because a respondent typically may require access to sensitive data stored in database 120 in order to respond to the questions or requirements in the respondent's assigned section or portion of the RFx, for security purposes, separate access clearance may be required for each separate section or portion of the RFx. Accordingly, each such separate section or portion of the RFx may be assigned its own sourcing “role” or means of identification. In turn, each respondent that will be providing responses for that specific section or portion is provided with the necessary role with which that respondent will be able to access the corresponding areas in the website maintained by system 32.

System 32 determines 416 whether a profile exists in system 32, and more specifically, database 120, for each respondent. For purposes of describing system 32, a profile is a set of data that serves to identify each respondent to an RFx. The set of data may include, among other data items, a respondent's name and other contact information, the identity of the prospective vendor the respondent represents, the username assigned by system 32 corresponding to that particular respondent, and, as described below, the sourcing role or roles assigned to that respondent. If no respondent profile exists, system 32 prompts 418 admin 30 to create a respondent profile for each respondent for which a profile is missing. System 32 then continues 420 the RFx creation process.

The RFx creation process continues 420 with system 32 prompting 422 admin 30 to assign sourcing roles to respondent profiles, as described above. System 32 then creates 424 RFx category headings. To do this, system 32 presents to admin 30 a series of previously-defined questions, stored in database 120, that are directed to the requirements of CE 22. Based on the answers provided by admin 30, system 32 selects and presents to admin 30 a list of possible services, also stored in database 120, to be covered by the RFx. System 32 then instructs 426 admin 30 to import, from a previously-defined instruction template(s), stored in database 120, a series of instructions for respondents to follow while completing the RFx.

System 32 accesses 428 a master template of questions, stored in database 120, for respondents to answer, for admin 30 to import into the RFx. System 32 stores in database 120 not only a master template of RFx questions, but also templates separated by category, so that individual templates include questions specific to particular topics, such as voice technology and service level agreement terms, MPLS (Multiprotocol Label Switching) technology and service level agreement terms, audio conferencing services technology and service level agreement terms, ISP (Internet Service Provider) technology and service level agreement terms, and wireless services technology and service level agreement terms. System 32 is configured so that admin 30 may select and insert into an RFx entire templates, or individually select and insert specific questions or groups of questions. System 32 is configured so that admin 30 or other authorized users may edit or supplement templates or individual questions, so that the library of RFx templates and questions stored in database 120 is a dynamic reservoir of questions for developing RFx's. During the process of selecting headings for an RFx, system 32 presents possible templates for admin 30 to import into the RFx, which templates are associated with the particular headings selected. If an RFx is going to be limited to one or two topics, admin 30 may be able to construct the RFx relying upon only one or two templates that may contain the questions and required procedural instructions necessary for a respondent to complete the RFx.

System 32 prompts 430 admin 30 to edit, move or otherwise manipulate the imported instructions and questions. System 32 prompts 432 admin 30 to supply any necessary documentation to support, supplement or clarify the instructions or questions contained in the RFx. If supporting documents exist or are required, system 32 prompts 434 admin 30 to upload the supporting documents. If no supporting documents exist or are required, system 32 determines 436 whether all sections of the RFx have been completed. If system 32 determines that sections of the RFx are incomplete, system 32 prompts admin 30 to import 428 additional questions and/or edit or revise 430 existing instructions and questions.

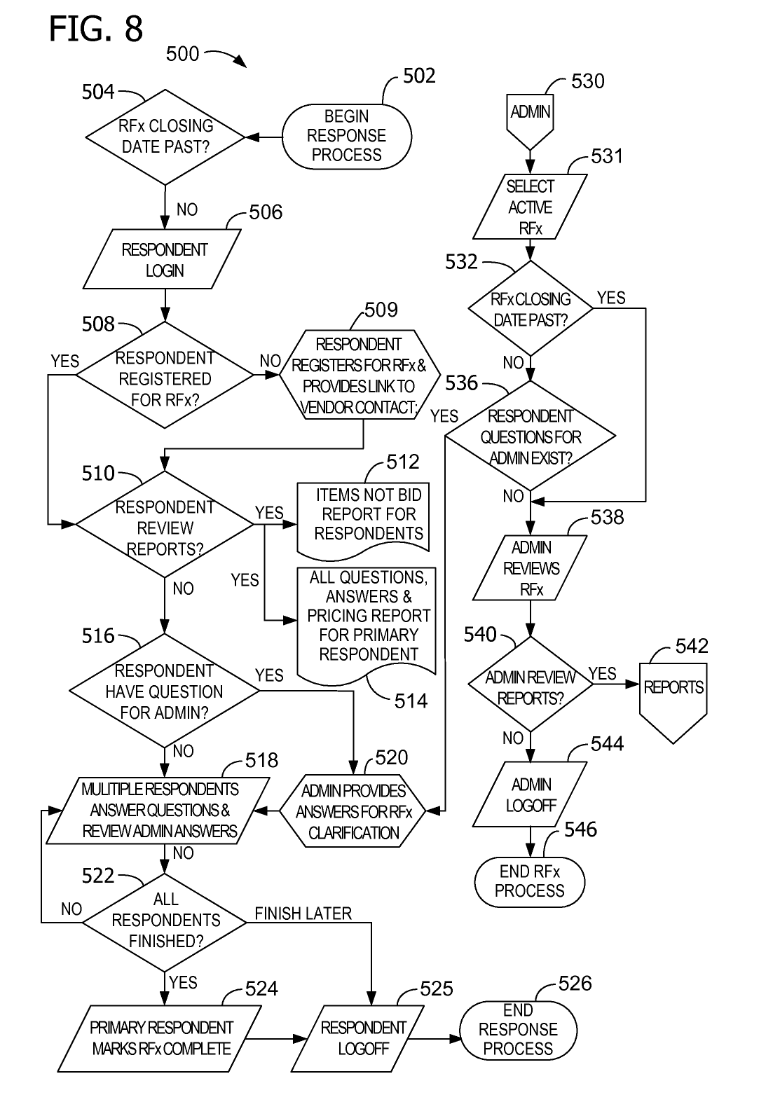

Once the RFx has been completed, system 32 prompts 438 admin 30 to provide invitations to prospective vendors, for example, via email. The invitations may be derived from a list based on respondent profiles previously entered into system 32. Admin 30 then logs off 440 system 32 to await further developments in the RFx process, as described with respect to FIG. 8.

FIG. 8 is a flowchart illustrating an exemplary method for receiving and analyzing responses to an RFx. In the exemplary embodiment, method 500 is performed by system 32 (shown in FIG. 1). RFx response process session 500, subsequent to the creation of the RFx and distribution of notice of the RFx to prospective vendors. RFx response process session 500 begins 502 once the RFx opening date has passed and continues until the RFx closing date. So long as the RFx closing date has not passed 504, a respondent (for this discussion, reference will be made to respondent(s) 24) logs 506 into system 32, using credentials or authorizations 438 provided by system 32. Respondent 24 accesses system 32 through a respondent portal interface. System 32 determines 508 whether respondent 24 is registered with system 32 and authorized to respond to RFx's. If system 32 determines that respondent 24 is not registered with system 32, system 32 prompts 509 respondent 24 to register and provides respondent 24 with a link to connect to a vendor's contacts registry in system 32. System 32 presents 510 respondent 24 with the opportunity to review reports system 32 has generated regarding the specific RFx in question, such as an “Items Not Bid” report 512. System 32 then asks 516 respondent 24 if respondent 24 has any questions to present to admin 30 regarding the RFx. If respondent 24 has questions, system 32 posts 536 those questions to a file stored in database 120, associated with the particular RFx in question, for admin 30 to review. If respondent 24 does not have questions for admin 30, or once admin 30 has responded 520 to the questions presented by respondent 24, system 32 receives 518 answers from respondents to the questions presented in the RFx and posts the answers admin 30 provided in response to questions from respondent 24.

System 32 is configured to enable documents to be uploaded and/or downloaded by admin 30 and/or respondent 24, as necessary to enable respondent 24 to address questions in an RFx and to enable admin 30 to address inquiries by respondent 24 and review and analyze completed responses to RFx's. For example, in order to enable a respondent 24 to have access to sensitive information of CE needed to prepare a response to an RFx; CE 22 may require respondent 24 to execute a non-disclosure agreement (“NDA”). Admin 30 will upload the NDA; respondent 24 will download the NDA, review and execute it, and upload it into system 32. Other documents may be similarly uploaded and/or downloaded by either admin 30 or respondent 24, such as master service agreements, diagrams of a communications network (referring to the example of an RFx for telecom services), reference materials, etc. System 32 further is configured to enable uploaded documents to be indexed; that is, associated in system 32, e.g., with particular questions and/or responses to those questions by a respondent with respect to a particular RFx. For example, CE 22 may require a non-disclosure agreement (“NDA”) to be executed by each respondent responding to an RFx in order to enable that respondent to be given access rights to enter responses to the RFx. System 32 is configured to enable a respondent 24 to complete and upload an NDA, and that NDA will be associated in system 32 with that particular respondent and the particular RFx in question.

System 32 determines 522 if all respondents (e.g., respondent 24) have answered all questions from the RFx. System 32 prompts respondents who have not responded to all questions in the RFx to complete their responses. Respondent 24 may complete responding to the RFx and mark 524 their response as complete. Alternatively, respondent 24 may choose to complete their responses to the RFx at a future time and simply log off 525 ending 526 their response session. Once a particular respondent has completed all of the questions it is going to answer in a particular RFx, system 32 inquires whether the respondent is going to commit to its responses. Once committed, a respondent may make no further changes to its responses, unless admin 30 re-launches (reopens) the RFx.

During the RFx response process session 500, system 32 allows admin 30 to log in 530 to review the status of the RFx. System 32 then prompts 531 admin 30 to select an open RFx matter to review from a listing of active RFx matters. If system 32 determines 532 that the RFx response closing date for the particular RFx admin 30 is reviewing has passed, then that particular RFx is ready for a final review and a decision on approval. If system 32 determines 532 that the response period has not passed, system 32 determines 536 whether any questions have been presented by respondents for admin 30 to answer. If such questions exist, as discussed above, admin 30 provides 520 answers to respondents' questions. If no questions exist, system 32 prompts 538 admin 30 to review the RFx and identify or confirm those respondents whose responses to the RFx qualify their respective prospective vendor(s) for selection for a final decision of approval or not.

System 32 assigns point values for each response (affirmative, negative, qualified) that respondent 24 submits in response to each question in the RFx. The point values may be assigned at the time when respondents provide answer 518 to questions in the RFx, or at a later time in process 500. For example, the questions in a section of the RFx may be phrased in such a way that a condition is presented, such as “will you (the vendor) provide a project manager to facilitate contract implementation?” and the respondent will be required to indicate agreement (worth one point) or disagreement (worth zero points) with the condition. Other questions may present multiple choice answers (in which one or more items may be selected), with one or more points assigned to each of the items (and answers to some items having higher point values than others). In an exemplary RFx, the point values for answers to specific questions may not be provided to the respondent. However, depending upon the nature of the RFx, and input from CE 22, the RFx may indicate that certain questions are “key” questions that must be answered in order for the respondent's response to the RFx to be considered, or that the responses to those “key” questions carry more weight than responses to other questions.

System 32 additionally prompts 540 admin 30 to review various reports (discussed in further detail below) system 32 has created based upon the responses made by respondent(s) 24. If admin 30 elects to review the report(s), system 32 presents 542 the reports as selected by admin 30. If admin 30 elects not to review the reports created by system 32, admin 30 logs off 544 to terminate 546 admin 30's participation in the RFx response session.

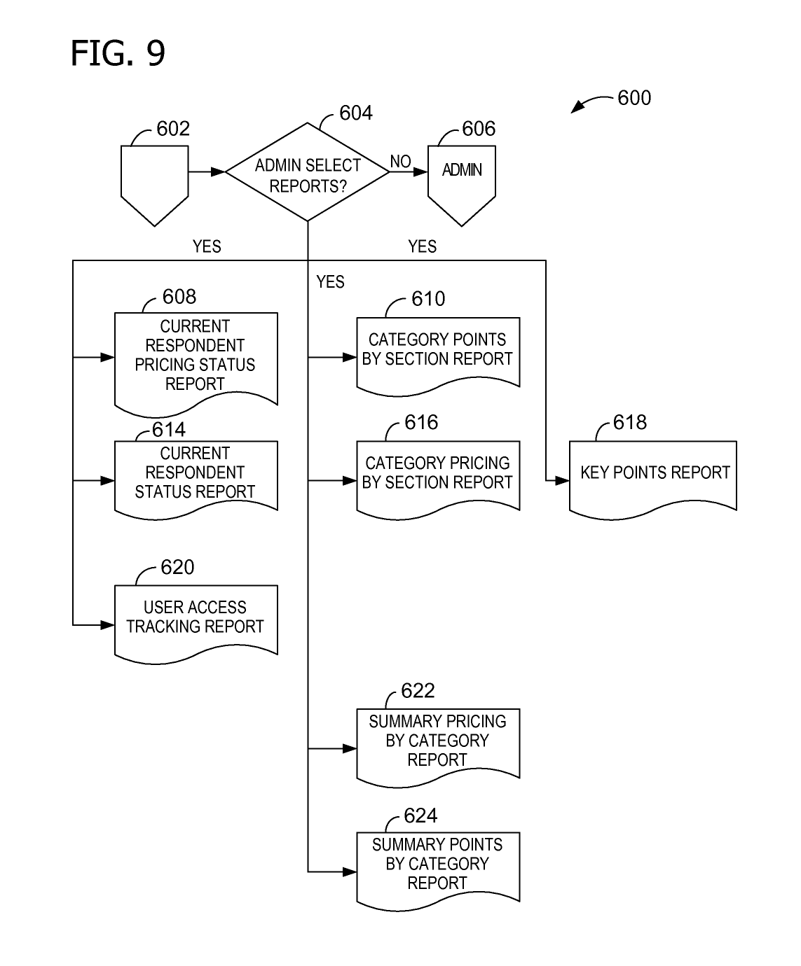

FIG. 9 illustrates an exemplary method 600 for creating and distributing reports, following the RFx response period, focusing on the role of admin 30 and the reports created by system 32 in response to answers provided by respondents during the RFx response period. Upon logging in 602, system 32 prompts admin 30 to select for review a variety of reports, for purposes of evaluating the responses received from respondent(s) 24, etc. The reports generated by system 32 are ongoing, meaning that for some respondents, the reports present information covering responses from respondents who have completed and committed to their responses to the RFx, while further information covers responses from respondents who are still completing their responses to the RFx. Depending upon how the role of admin 30 was defined by CE 22 at the beginning of any specific RFx process, admin 30 may select 604 reports for review and analysis. Alternatively, the role of admin 30 may terminate 606 once all respondents have completed their responses to a given RFx, and system 32 has generated final reports for each category of report discussed above. In an exemplary embodiment, system 32 creates the aforementioned reports at predetermined regular intervals, and/or on command of admin 30, if a more up-to-date report is required.

A Current Respondent Pricing Status Report 608 provides a listing of totals, by vendor, for the total number of items in the RFx that respondents responded to, the total number of bids for individual items in the RFx that the responded provided, and the percentage of a total number of responses received from each respondent, out of the total number of questions presented in the RFx.

A Category Points by Section Report 610 shows each category and the sections within that category, and includes a comparison of the various respondents' points. Report 610 is, in an exemplary embodiment, broken down to provide in a first column or row, points awarded to a respondent 24 based upon the answers provided by respondent 24. A second column or row provides total points available and a third column or row provides the percentage of the total points the respondent received.

A Current Respondent Status report 614 shows the status of each respondent, including the date and time of the most recent login by that respondent, the percentage of questions from the RFx that the respondent has answered, and whether the respondent has committed to the answers provided.

A Category Pricing by Section report 616 shows each category and the sections within that category, and includes a comparison of respondent's prices. Report 616 is, in an exemplary embodiment, may include further information, broken down by respondent and then by service type, such as “bid status”, “best of market”, “current cost”, “bid cost” and “savings.” Report 616 additional provides a final summary line having totals, per vendor, including the same categories of information. “Best of market” refers to a table of pricing data developed by the CE, to which respondents have access, which indicates goal or objective pricing for a specific RFx item or items, as determined by the CE.

A Key Points report 618 shows how the various respondents compare on various critical questions or “key points” that have been previously defined for a specific RFx. Report 618 lists each question in the RFx with all of the respondents' answers listed respectively. Report 618 also includes listings of points awarded, total points available, and percentage points awarded, per respondent.

A User Access Tracking report 620 shows a detail line for each user logout action. The detail lines are grouped by respondent, and include details such as full name, login and logout date(s) and time(s), logout method and usage. “Logout method” refers to the fact that a respondent may log out or be logged out of the on-line facility through one of three modes: 1) orderly logout using a logout button on the webpage; 2) involuntary logout due to time out following inactivity; and 3) logout through the respondent or other party closing the web browser. “Usage” refers to data that records a respondent's activity, such as counting each time a respondent visits the RFx webpage, writes or updates a record, uploads a document, etc., to create an audit trail.

A Summary Pricing by Category report 622 shows top level categories, as previously defined (by admin 30 or CE 22) in technical, contract and administrative question parts of the RFx with a comparison of each respondent's prices, shown as monthly rates. Report 622 is, in an exemplary embodiment, further broken down by respondent and then category, and further includes entries for items such as “bid status”, “best of market”, “current cost”, “bid cost” and “savings.” Each category is further provided with a savings total column or row.

A Summary Points by Category report 624 shows top level categories, as previously defined (by admin 30 or CE 22) in technical, contract and administrative question parts of the RFx with a comparison of each respondent's points awarded for their answers. As with report 610, report 624 is broken down to provide in a first column or row, points awarded to a respondent 24 based upon the answers provided by respondent 24. A second column or row provides total points available and a third column or row provides the percentage of the total points the respondent received. Grand total summary lines show total points awarded and total points available, per respondent.

System 32 creates additional reports (not shown) such as an items not bid report, which identifies, by respondent, those items in the RFx, for which responses or bids were not received; and an unanswered questions report. Admin 30 will have access to all reports generated by system 32. Admin 30 and/or CE 22 may select certain ones of the reports to be accessible by respondents 24, etc. through the respondent portal interface. In addition to providing numerical data, the reports may be color coded, for example to indicate by color whether a given respondent's responses fall within a certain range and providing a characterization of that range. For example, a point total of 70% or greater of available points may be colored green, representing a good total; a percentage between 56% and 69% may be colored yellow representing caution, and a percentage below 56% may be colored red for bad or undesirable.

The systems and methods are not limited to the specific embodiments described herein. In addition, components of each system and each method can be practiced independent and separate from other components and methods described herein. Each component and method also can be used in combination with other components and processes.

The methods and systems described herein facilitate efficient and economical management of sourcing of strategic resources, such as telecommunications services, for a commercial entity. Exemplary embodiments of methods and systems are described and/or illustrated herein in detail. The methods and systems are not limited to the specific embodiments described herein, but rather, components of each system, as well as steps of each method, may be utilized independently and separately from other components and steps described herein. Each component, and each method step, can also be used in combination with other components and/or method steps.

When introducing elements/components/etc. of the methods and systems described and/or illustrated herein, the articles “a”, “an”, “the”, and “said” are intended to mean that there are one or more of the element(s)/component(s)/etc. The terms “comprising”, “including”, and “having” are intended to be inclusive and mean that there may be additional element(s)/component(s)/etc. other than the listed element(s)/component(s)/etc.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-based method for management of sourcing of a strategic resource for a commercial entity, said method implemented using a computer system that includes a processor and a memory device, said method comprising:
providing a web-based access interface to enable at least one of an administrator, and at least one respondent representing a prospective vendor to interact with, upload data into and download information from a web-based strategic resource sourcing management system;
storing a plurality of questions in a database, the questions being directed to one or more of a plurality of discrete topics concerning a strategic resource;
creating a request, using the computer system, and with criteria provided by at least one of the administrator and the commercial entity, the request incorporating one or more questions from the plurality of questions stored in the database;
receiving, from the at least one respondent, a response; and
generating, using the computer system, at least one report, based on criteria provided by at least one of the administrator and the commercial entity, using data derived from the response, the report providing information to enable at least one of the administrator and the commercial entity to arrive at a decision whether to select the prospective vendor represented by the at least one respondent to provide a strategic resource to the commercial entity.

2. A computer-based method in accordance with claim 1, wherein storing a plurality of questions in a database, the questions being directed to one or more of a plurality of discrete topics concerning a strategic resource comprises:
storing one or more templates in the database, wherein each template comprises one or more questions directed to a specific topic relating to a strategic resource.

3. A computer-based method in accordance with claim 1, further comprising:
receiving, using the computer system, at least one document uploaded by at least one of the administrator and at least one respondent, the at least one document including data for facilitating preparation, by the at least one respondent, of the answers to the questions contained in the request.

4. A computer based method in accordance with claim 1, wherein the request further comprises:
one of a request for information regarding provision of a strategic resource for the commercial entity, a request for quotation regarding provision of a strategic resource for the commercial entity, and a request for proposal regarding provision of a strategic resource for the commercial entity.

5. A computer based method in accordance with claim 1, wherein the strategic resource for the commercial entity comprises telecommunications services.

6. A computer-based method in accordance with claim 1, further comprising:
issuing, using the computer system, a communication to the at least one respondent, informing the at least one respondent of the request and inviting the at least one respondent to respond to the request.

7. A computer-based method in accordance with claim 1, further comprising:
receiving, using the computer system, at least one question from the at least one respondent pertaining to the request; and
communicating, using the computer system, the at least one question received from the at least one respondent to the administrator.

8. A computer-based method in accordance with claim 1, further comprising:
assigning, using the computer system, point values to responses provided by the at least one respondent to the questions in the request.

9. A computer-based method in accordance with claim 8, wherein the at least one respondent comprises at least two respondents, the method further comprising:
ranking, using the computer system, the at least two respondents based on respective points accumulated in responding to the questions in the request.

10. A computer-based method in accordance with claim 1, further comprising:
monitoring, using the computer system, the status of the at least one respondent with respect to whether the at least one respondent has completed answering the questions in the request.

11. A computer-based method in accordance with claim 8, wherein the at least one respondent comprises at least two respondents, and the report comprises one of a report ranking the at least two respondents according to at least one of amount of questions answered, percentage of questions answered, points assigned, percentage of points assigned relative to points available.

12. A system for managing the sourcing of a strategic resource for a commercial entity, said system incorporating a computer system that includes a processor and a memory device, said system comprising:
a database configured to store data associated with at least one of an administrator, a commercial entity, and at least one respondent representing a prospective vendor;
a database server; and
one or more computers, each computer including a processing device and a memory;
the database, database server, and one or more computers being configured to:
provide a web-based access interface to enable at least one of the administrator, commercial entity, and at least one respondent representing a prospective vendor to upload data into and download information from the database;
store a plurality of questions in a database, the questions being directed to one or more of a plurality of discrete topics concerning a strategic resource;
create a request, using the computer system, and with criteria provided by at least one of the administrator and the commercial entity, the request incorporating one or more questions from the plurality of questions stored in the database;
receive a response from the at least one respondent; and
generate, using the computer system, at least one report, based on criteria provided by at least one of the administrator and the commercial entity, using data derived from the response, the report providing information to enable at least one of the administrator and the commercial entity to arrive at a decision whether to select the prospective vendor represented by the at least one respondent to provide a strategic resource to the commercial entity.

13. A system for managing the sourcing of a strategic resource for a commercial entity according to claim 12, comprising:
one or more templates stored in the database, wherein each template comprises one or more questions directed to a specific topic relating to a strategic resource.

14. A system in accordance with claim 12, further comprising:
the database, database server, and one or more computers being further configured to:
receive, using the computer system, at least one document uploaded by at least one of the administrator and at least one respondent, the at least one document including data for facilitating preparation, by the at least one respondent, of the answers to the questions contained in the request.

15. A system in accordance with claim 12, wherein the request further comprises:
one of a request for information regarding provision of a strategic resource for the commercial entity, a request for quotation regarding provision of a strategic resource for the commercial entity, and a request for proposal regarding provision of a strategic resource for the commercial entity.

16. A system in accordance with claim 12, wherein the strategic resource for the commercial entity comprises telecommunications services.

17. A system in accordance with claim 12, further comprising:
the database, database server, and one or more computers being further configured to:
issue, using the computer system, a communication to the at least one respondent, informing the at least one respondent of the request and inviting the at least one respondent to respond to the request.

18. A system in accordance with claim 12, further comprising:
the database, database server, and one or more computers being further configured to:
receive, using the computer system, at least one question from the at least one respondent pertaining to the request; and
communicate, using the computer system, the at least one question received from the at least one respondent to the administrator.

19. A system in accordance with claim 12, further comprising:
the database, database server, and one or more computers being further configured to:
assign, using the computer system, point values to responses provided by the at least one respondent to the questions in the request.

20. A system in accordance with claim 19, wherein the at least one respondent comprises at least two respondents, further comprising:
the database, database server, and one or more computers being further configured to:
rank, using the computer system, the at least two respondents based on respective points accumulated in responding to the questions in the request.

21. A system in accordance with claim 12, further comprising:
the database, database server, and one or more computers being further configured to:
monitor, using the computer system, the status of the at least one respondent with respect to whether the at least one respondent has completed answering the questions in the request.

22. A system in accordance with claim 19, wherein the at least one respondent comprises at least two respondents, and the report comprises one of a report ranking the at least two respondents according to at least one of amount of questions answered, percentage of questions answered, points assigned, percentage of points assigned relative to points available.

23. One or more non-transitory computer-readable storage media having computer-executable instructions embodied thereon, wherein when executed by at least one processor, the computer-executable instructions cause the processor to:
store a plurality of questions in a database, the questions being directed to one or more of a plurality of discrete topics concerning a strategic resource;
create a request, using the computer system, and with criteria provided by at least one of the administrator and the commercial entity, the request incorporating one or more questions from the plurality of questions stored in the database;
receive a response from the at least one respondent; and
generate, using the computer system, at least one report, based on criteria provided by at least one of the administrator and the commercial entity, using data derived from the response, the report providing information to enable at least one of the administrator and the commercial entity to arrive at a decision whether to select the prospective vendor represented by the at least one respondent to provide a strategic resource to the commercial entity.

24. The computer-readable storage media of claim 23, wherein the computer-executable instructions further cause the processor to:
store in the database one or more templates, wherein each template comprises one or more questions directed to a specific topic relating to a strategic resource.

25. The computer-readable storage media of claim 23, wherein the computer-executable instructions further cause the processor to:
receive, using the computer system, at least one document uploaded by at least one of the administrator and at least one respondent, the at least one document including data for facilitating preparation, by the at least one respondent, of the answers to the questions contained in the request.

26. The computer-readable storage media of claim 23, wherein the request further comprises:
one of a request for information regarding provision of a strategic resource for the commercial entity, a request for quotation regarding provision of a strategic resource for the commercial entity, and a request for proposal regarding provision of a strategic resource for the commercial entity.

27. The computer-readable storage media of claim 23, wherein the strategic resource for the commercial entity comprises telecommunications services.

28. The computer-readable storage media of claim 23, wherein the computer-executable instructions cause the processor to:
issue, using the computer system, a communication to the at least one respondent, informing the at least one respondent of the request and inviting the at least one respondent to respond to the request.

29. The computer-readable storage media of claim 23, wherein the computer-executable instructions cause the processor to:
receive, using the computer system, at least one question from the at least one respondent pertaining to the request; and
communicate, using the computer system, the at least one question received from the at least one respondent to the administrator.

30. The computer-readable storage media of claim 23, wherein the computer-executable instructions cause the processor to:
assign, using the computer system, point values to responses provided by the at least one respondent to the questions in the request.

31. The computer-readable storage media of claim 23, wherein the computer-executable instructions cause the processor to:
rank, using the computer system, the at least two respondents based on respective points accumulated in responding to the questions in the request.

32. The computer-readable storage media of claim 23, wherein the computer-executable instructions cause the processor to:
monitor, using the computer system, the status of the at least one respondent with respect to whether the at least one respondent has completed answering the questions in the request.

33. The computer-readable storage media of claim 23, wherein the at least one respondent comprises at least two respondents, and the report comprises one of a report ranking the at least two respondents according to at least one of amount of questions answered, percentage of questions answered, points assigned, percentage of points assigned relative to points available.
